(19) United States
(12) Patent Application Publication
(10) Pub. No.: US 2016/0139819 A1
(43) Pub. Date: May 19, 2016

(54) COMPUTER-READABLE RECORDING MEDIUM, ENCODING DEVICE AND ENCODING METHOD

(71) Applicant: FUJITSU LIMITED, Kawasaki-shi (JP)

(72) Inventors: Masahiro KATAOKA, Kamakura (JP); Ryo MATSUMURA, Numazu (JP); Takaki OZAWA, Numazu (JP)

(73) Assignee: FUJITSU LIMITED, Kawasaki-shi (JP)

(21) Appl. No.: 14/936,841

(22) Filed: Nov. 10, 2015

(30) Foreign Application Priority Data
Nov. 18, 2014 (JP) 2014-233743

(51) Int. Cl. G06F 3/06

(52) U.S. Cl. CPC G06F 3/0608; G06F 3/0659; G06F 3/0673

(57) ABSTRACT

An information processing apparatus splits a word to be encoded into a plurality of word elements. The information processing apparatus obtains a plurality of hashed word elements by hashing each of the plurality of word elements, number of bits of each of the plurality of hashed word elements corresponding to a position of each of the plurality of word elements in the word, respectively. The information processing apparatus outputs an encoding result that the plurality of the hashed word elements are combined.

### CROSS-REFERENCE TO RELATED APPLICATION(S)

This application is based upon and claims the benefit of priority of the prior Japanese Patent Application No. 2014-233743, filed on Nov. 18, 2014, the entire contents of which are incorporated herein by reference.

### FIELD

The embodiments discussed herein are directed to a computer-readable recording medium or the like.

### BACKGROUND

There is a technology that hashes a character strings by using a hash function when an input character string is searched from character strings registered in a dictionary and that searches for a target character string.

For example, a document processing unit associates a calculation value calculated on the basis of a predetermined rule with the frequency of appearance that indicates the frequency of calculation of the calculation value and then stores the association relationship in a storing unit. The document processing unit splits a document into several character strings on the basis of a predetermined condition and then calculates, from each of the split character strings on the basis of the predetermined rule, a calculation value (hash value) that is unique to each of the character strings. Then, the document processing unit detects the frequency of appearance that is associated with each of the calculated calculation values; selects one or more calculation values on the basis of each of the frequencies of appearances associated with each of the detected calculation values; and searches for (extracts) character strings associated with the one or more selected values as the summary of the document.

Patent Document 1: Japanese Laid-open Patent Publication No. 2003-30030

When an input character string is searched from among character strings registered in a dictionary, if the number of bits output from a hash function is reduced, overlapping (synonyms) of output values occurs and thus the number of character strings to be checked against the input character string is increased. Consequently, it takes time for a batch search of all the character strings. Furthermore, if a large number of bits output from a hash function are held to some extent, the number of hash values in each of which a character string has not been registered is increased and thus the data size of the hash becomes large.

### SUMMARY

According to an aspect of an embodiment, a non-transitory computer-readable recording medium stores a encoding program. The program causes a computer to execute a process. The process includes splitting a word to be encoded into a plurality of word elements. The process includes obtaining a plurality of hashed word elements by hashing each of the plurality of word elements, number of bits of each of the plurality of hashed word elements corresponding to a position of each of the plurality of word elements in the word, respectively. The process includes outputting an encoding result that the plurality of the hashed word elements are combined.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a search process according to a reference example;

FIG. 2 is a schematic diagram illustrating an example of a bit filter according to the reference example;

FIG. 3 is a schematic diagram illustrating an example of a search process according to a first embodiment;

FIG. 4 is a schematic diagram illustrating an example of a bit filter according to the first embodiment;

FIG. 5 is a schematic diagram illustrating the functional configuration of an information processing apparatus according to the first embodiment;

FIG. 6 is a flowchart illustrating an example of the flow of the search process according to the first embodiment;

FIG. 7 is a schematic diagram illustrating an example of a search process according to a second embodiment;

FIG. 8 is a schematic diagram illustrating the functional configuration of an information processing apparatus according to a second embodiment;

FIG. 9 is a flowchart illustrating an example of the flow of the search process according to the second embodiment;

FIG. 10 is a schematic diagram illustrating a specific example of a word encoding process according to the second embodiment;

FIG. 11 is a schematic diagram illustrating an example of a search process according to a third embodiment;

FIG. 12 is a schematic diagram illustrating character string distribution;

FIG. 13 is a schematic diagram illustrating the functional configuration of an information processing apparatus according to a third embodiment;

FIG. 14 is a schematic diagram illustrating an example of the data structure of a character string distribution table according to the third embodiment;

FIG. 15 is a flowchart illustrating an example of the flow of a search process according to the third embodiment;

FIG. 16 is a block diagram illustrating the hardware configuration of the information processing apparatus according to the first to the third embodiments; and

FIG. 17 is a schematic diagram illustrating an example of the configuration of a program running on a computer.

### DESCRIPTION OF EMBODIMENTS

Preferred embodiments of the present invention will be explained with reference to accompanying drawings. It is assumed that the search program includes the encoding program. The present invention is not limited to the embodiments.

Search Process According to a Reference Example

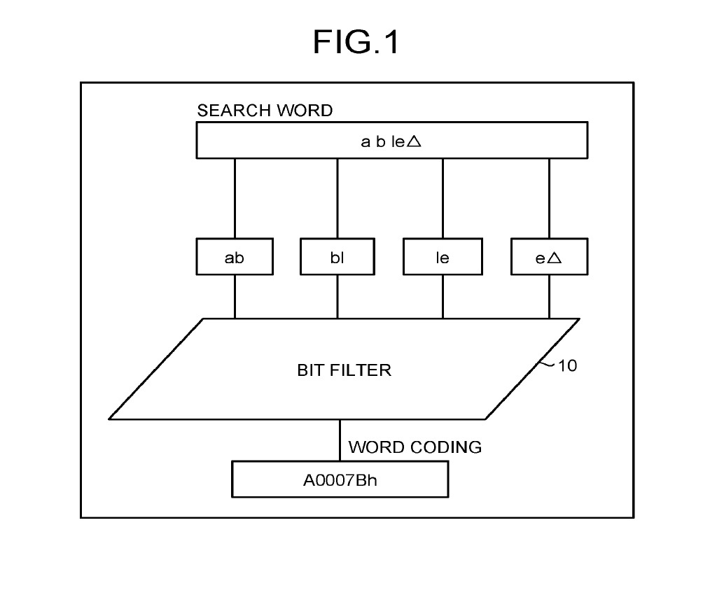

First, an encoding process performed by an information processing apparatus according to a reference example will be described with reference to FIG. 1. FIG. 1 is a schematic diagram illustrating an example of a search process according to a reference example. As illustrated in FIG. 1, the information processing apparatus splits “ableΔ” that is included in a word targeted for a search (search word) into a set of two words, such as “ab”, “bl”, “le”, and “eΔ”, and acquires each character string. The search word is constituted of an English word of n characters and a terminal symbol of a single character. The terminal symbol is a symbol of a blank (space), a comma (,), or a period (.). In the first embodiment, as an example, the terminal symbol is represented by “Δ (triangle)”.

The information processing apparatus outputs each of the acquired character strings to a bit filter 10. The information processing apparatus compares the bit filter 10 with each of the acquired character strings and determines whether the character strings in the search word is hit in the bit filter 10. The bit filter 10 is a dictionary in which a word code is associated with each word. In the bit filter 10, a word code associated with each of the words is previously registered. For example, in the bit filter 10, word codes of “A0007Bh”, “A00091h”, and . . . associated with the respective words of “able”, “about”, and . . . are sequentially and previously registered. Furthermore, a description has been given of a case in which the bit filter 10 is a dictionary in which the word codes are associated with the respective words; however, the bit filter 10 is not limited thereto but a compressed code may also further be associated with each of the words.

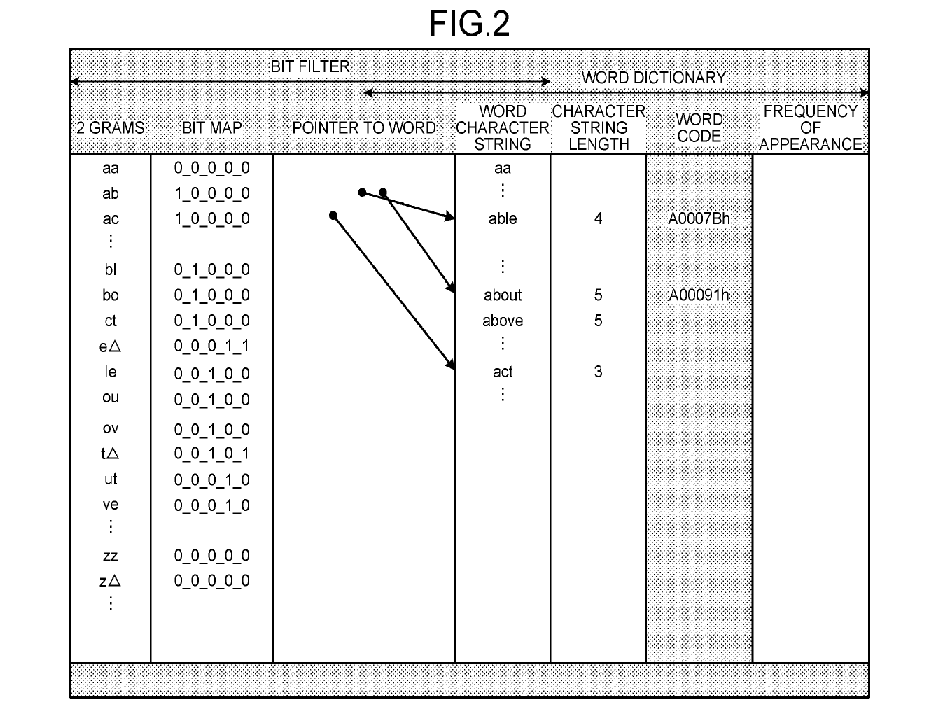

In the following, the data structure of the bit filter 10 according to the reference example will be described with reference to FIG. 2. FIG. 2 is a schematic diagram illustrating an example of a bit filter according to the reference example. As illustrated in FIG. 2, the bit filter 10 includes, in an associated manner, 2 grams, a bit map, a word character string, a character string length, a word code, and the frequency of appearance. The item of the “2 grams” is a consecutive character string included in each word. For example, “able” includes 2 grams that are associated with “ab”, “bl”, “le”, and “eΔ”.

The “bit map” represents a bit map associated with a character string of 2 grams. As an example, the 2 grams of “ab” is associated with the bit map of “1_0_0_0_0”. The 2 grams of “bl” is associated with the bit map of “0_1_0_0_0”. The “word character string” is a character string in the word registered in the bit filter 10. For example, the word character string of “able” is associated, by a pointer to a word, with the bit map “1_0_0_0_0” that is associated with the 2 grams “ab”, with the bit map “0_1_0_0_0” that is associated with the 2 grams “bl”, with the bit map “0_0_1_0_0” that is associated with the 2 grams “le”, and with the bit map “0_0_0_1_1” that is associated with the 2 grams “eΔ”.

For example, when the information processing apparatus acquires “able” as a search word, the information processing apparatus compares the bit filter 10 with “ab” and acquires the bit map “1_0_0_0_0” that is associated with the 2 grams “ab”. The information processing apparatus compares the bit filter 10 with “bl” and acquires the bit map “0_1_0_0_0” that is associated with the 2 grams “bl”. The information processing apparatus compares the bit filter 10 with “le” and acquires the bit map “0_0_1_0_0” that is associated with the 2 grams “le”. The information processing apparatus compares the bit filter 10 with “eΔ” and acquires the bit map “0_0_0_1_1” that is associated with the 2 grams “eΔ”. The information processing apparatus determines, by using “1_0_0_0_0”, “0_1_0_0_0”, “0_0_1_0_0”, and “0_0_0_1_1” that are the acquired bit maps, whether a hit occurs in the word character string “able”.

The “character string length” is the length of each of the word character strings. The “word code” is a code to be allocated to each of the word character strings. For example, in the word code, the word codes of “A0007Bh”, “A00091h”, and . . . associated with the respective word character strings of “able”, “about”, and . . . are allocated.

A description will be given here by referring back to FIG. 1. If a character string in a search word is hit in the word character string, the information processing apparatus outputs the associated word code to the word character string. In the example illustrated in FIG. 2, because the character string of the search word is hit in the word character string “able”, the information processing apparatus outputs the word code “A0007Bh” that is associated with the word character string “able”.

In this way, in the encoding process according to the reference example, when a character string in a word is searched, if the size of the bit filter 10 to be referred to, such as 2 grams, the number of “misses” is small. This is because each of the character strings of 2 grams in the bit filter 10 has relationship with the word. However, because the reference needs to be repeatedly performed many times, it takes a long time to search a character string in a word. In contrast, if the size of the bit filter 10 to be referred to, such as N (N>2) grams, the number of “misses” becomes large in each reference. This is because each of the character strings of N grams in the bit filter 10 has less relationship with the word. Namely, in each of the character strings of N grams in the bit filter 10, a lot of “miss” character strings that have no relationship with the word are included. In particular, in order to complete a search of a character string in a word by a single check, because there is a need for referring to the bit filter 10 of N grams in accordance with the number of characters in the character string in the word, it takes a long time to search the character string in the word.

### [a] First Embodiment

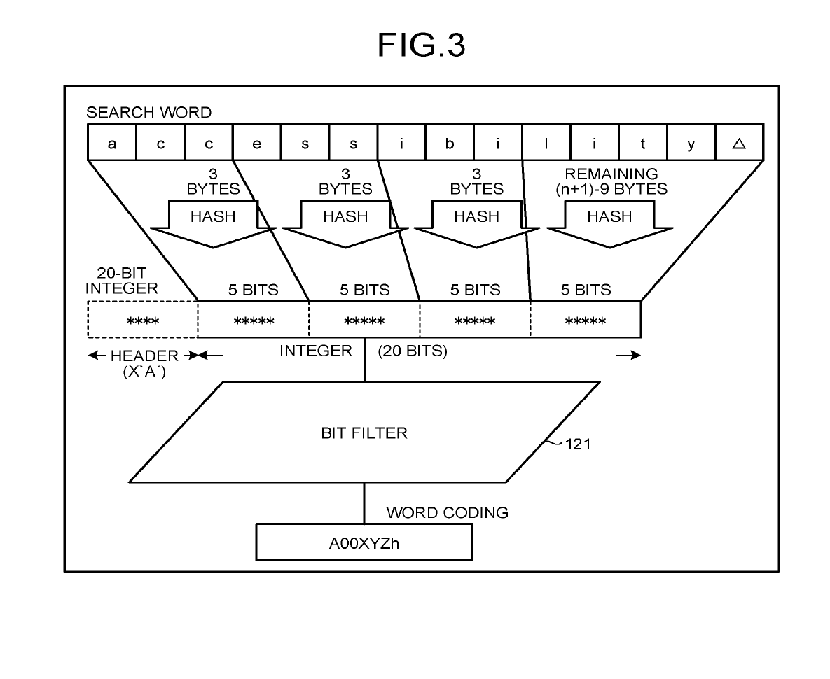

Search process according to the first embodiment A search process according to the first embodiment will be described with reference to FIG. 3. FIG. 3 is a schematic diagram illustrating an example of a search process according to a first embodiment. As illustrated in FIG. 3, an information processing apparatus 100 splits “accessibilityΔ” that is included in a word targeted for a search (search word) into 3 bytes, 3 bytes, 3 bytes, and the remaining bytes, such as “acc”, “ess”, “ibi”, and “lityΔ”.

The information processing apparatus 100 controls a hash operation so as to obtain a hash word element of the number of bits in accordance with the position of each of the word elements, in the search word, of “acc”, “ess”, “ibi”, and “lityΔ” that are obtained from the split. The hash word element includes the hash value. For example, the information processing apparatus 100 controls the hash operation so as to obtain a hash word element of 5 bits in accordance with the position of the forefront element “acc” in the search word. The information processing apparatus 100 controls the hash operation so as to obtain a hash word element of 5 bits in accordance with the position of the second element “ess” in the search word. The information processing apparatus 100 controls the hash operation so as to obtain a hash word element of 5 bits in accordance with the position of the subsequent word element “ibi” in the search word. The information processing apparatus 100 controls the hash operation so as to obtain a hash word element of 5 bits in accordance with the position of the remaining word element “lityΔ” in the search word. However, in the first embodiment, because the hash word elements with the same number of bits are obtained in accordance with their position, the same hash function may be used in the hash operation.

The information processing apparatus 100 combines, for the plurality of word elements, each of the hash word elements obtained from the hash operation and creates a 20-bit integer as an encoding result. Namely, the information processing apparatus 100 creates, from a character string of n+1 grams that constitutes a search word, a 20-bit integer by using the hash word elements. In the example illustrated in FIG. 3, n+1 is a value obtained by adding “13”, which is the character string length of the character string constituting the search word, to “1”, which is the length of the space that indicates the termination, and “14” is obtained.

In the following, the relationship between words in an English-Japanese dictionary and a 20-bit integer will be described. In the English-Japanese Dictionary for the General Reader, about 270,000 words are contained. In the Oxford Advanced Learner's Dictionary, about 500,000 words are contained. In the both dictionaries, the number of words is within 1,000,000 words. In contrast, because 20 bits is a maximum of 1 MB (megabyte), 1,000,000 words can be represented. Namely, in the both dictionaries, the words can be identified by the 20-bit integer. By using the 20-bit integer, the information processing apparatus 100 completes a search of a search word from a bit filter 121 by a single check. Furthermore, it is conceivable that the result of the hash operation performed on all of the search words is used as an encoding result. However, in this case, in order to guarantee the uniformity and the independency of the hash, there is a need to sufficiently ensure the number of bits (greater than 20 bits) of the hash word element. In order to sufficiently ensure the number of bits of the hash word element, it takes a long time even if a search of a search word is completed by a single check.

The information processing apparatus 100 outputs the 20-bit integer created as the encoding result to the bit filter 121. The information processing apparatus 100 compares the bit filter 121 with the 20-bit integer and determines whether the character string in the search word is hit in the bit filter 121. The bit filter 121 means, similarly to the bit filter 10 according to the reference example, a dictionary in which a word codes are associated with words. In the bit filter 121, the word codes associated with the respective words are registered. For example, in the bit filter 121, word codes of “A0007Bh”, “A00091h”, and . . . associated with the respective words of “able”, “about”, and . . . are sequentially and previously registered. Furthermore, an example has been given of a case in which the bit filter 121 in which the word codes are associated with the respective words; however, the bit filter 121 is not limited thereto but a compressed code may also further be associated with each of the words.

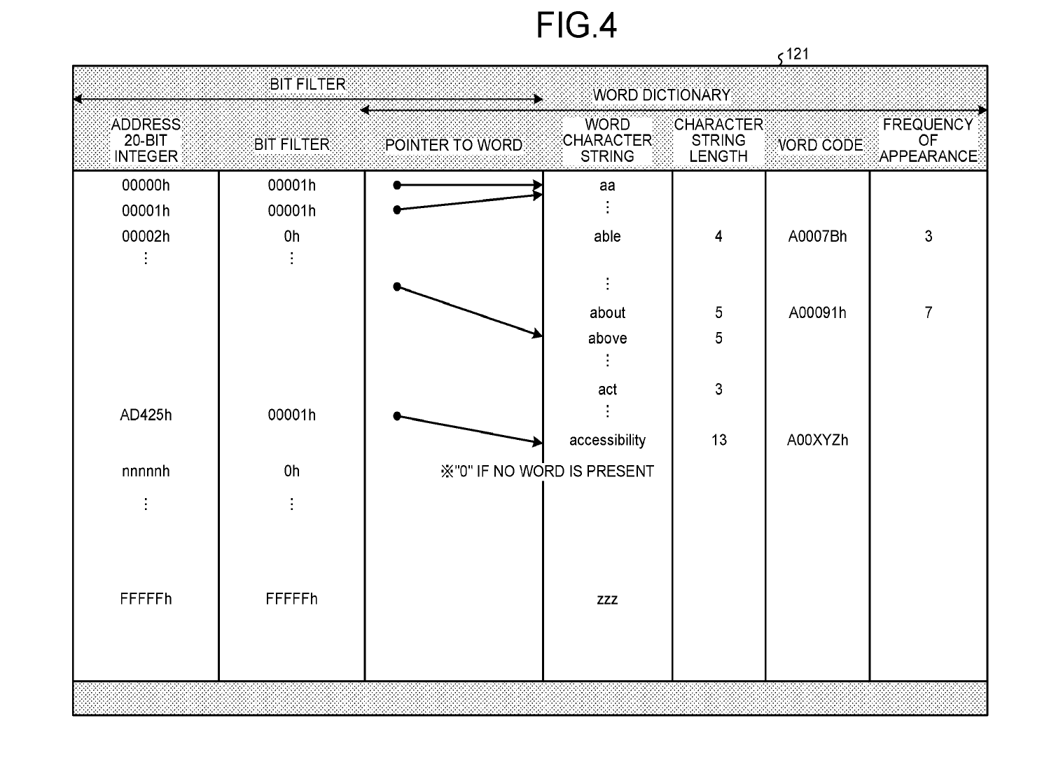

In the following, the data structure of the bit filter 121 according to the first embodiment will be described with reference to FIG. 4. FIG. 4 is a schematic diagram illustrating an example of a bit filter according to the first embodiment. As illustrated in FIG. 4, the bit filter 121 includes, in an associated manner, a 20-bit integer as an address, a bit filter, a word character string, a character string length, a word code, and the frequency of appearance.

The “20-bit integer” is a 20-bit integer of an address of a word character string. The “20-bit integer” is registered such that consecutive 20-bit integers, such as hexadecimal numbers of “00000”, “00001”, “00002”, . . . , and “FFFFF”, are registered. For example, in a case of “accessibilityΔ”, the 20-bit integer associated with “acc, “ess”, “ibi”, and “lityΔ” is included. Namely, in this 20-bit integer, the 20-bit integer obtained by combining the hash word element of 5 bits associated with “acc”, the hash word element of 5 bits associated with “ess”, the hash word element of 5 bits associated with “ibi”, and the hash word element of 5 bits associated with “lityΔ” as an encoding result is registered.

The “bit filter” represents a bit filter associated with the “20-bit integer”. Namely, the “bit filter” indicating the presence or absence of a word character string associated with the “20-bit integer” that is obtained when a word is encoded by using the same method as that used to encode a search word to a 20-bit integer. As an example, if the “bit filter” is “00001h”, this indicates the presence, whereas, if the “bit filter” is “Oh”, this indicates the absence. The “word character string” is a character string of a word registered in the bit filter 121. For example, the word character string “accessibility” is associated with the bit filter “00001h” with the 20-bit integer “AD425h” by a pointer to the word.

For example, if the information processing apparatus 100 acquires “accessibility” as a search word, the information processing apparatus 100 creates the 20-bit integer “AD425h” as the encoding result. The information processing apparatus 100 compares the bit filter 10 with “AD425h” that has been created as the encoding result and acquires the bit filter that is associated with the 20-bit integer “AD425h”. The information processing apparatus 100 determines whether a hit occurs in the word character string “accessibility” by using the bit filter.

The “character string length” is the length of each of the word character strings. The “word code” is a code that is allocated to each of the word character strings. For example, the word codes of “A0007Bh”, “A00091h”, and . . . associated with the respective word character string “able”, “about”, and . . . are allocated to the word codes.

A description will be given here by referring back to FIG. 3. If a character string of a search word is hit in a word character string, the information processing apparatus 100 outputs the word code that is associated with the word character string. In the example illustrated in FIG. 4, because the character string of the search word is hit in the word character string “accessibility”, the information processing apparatus 100 outputs the word code “A00XYZh” that is associated with the word character string “accessibility”.

Functional Configuration of the Information Processing Apparatus According to the First Embodiment

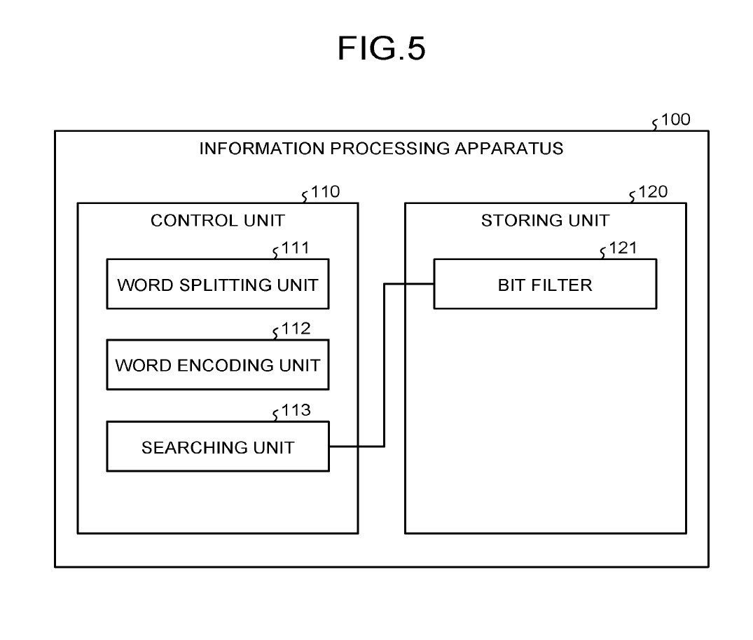

In the following, the information processing apparatus 100 that performs the search process according to the first embodiment will be described with reference to FIG. 5. FIG. 5 is a schematic diagram illustrating the functional configuration of an information processing apparatus according to the first embodiment. As illustrated in FIG. 5, the information processing apparatus 100 includes a control unit 110 and a storing unit 120.

The control unit 110 includes an internal memory that stores therein control data and programs in which various kinds of procedures are prescribed, whereby various kinds of processes are executed. The control unit 110 corresponds to, for example, an electronic circuit, such as an ASIC, an FPGA, or the like, in an integrated circuit. Alternatively, the control unit 110 corresponds to an electronic circuit, such as a CPU, an MPU, or the like. Furthermore, the control unit 110 includes a word splitting unit 111, a word encoding unit 112, and a searching unit 113.

The storing unit 120 corresponds to, for example, a storage device that is a nonvolatile semiconductor memory device, such as a flash memory, an FRAM (registered trademark), or the like. The storing unit 120 includes the bit filter 121. The configuration of the bit filter 121 is the same as that illustrated in FIG. 4; therefore, a description thereof will be omitted.

The word splitting unit 111 splits a word targeted for a search (search word). For example, when the word splitting unit 111 acquires a search word, the word splitting unit 111 splits the acquired search word into every 3 bytes from the top. The word splitting unit 111 acquires a plurality of word elements obtained from the splitting of the search word.

The word encoding unit 112 encodes the word elements obtained from splitting the search word to 20 bits by hashing. For example, the word encoding unit 112 controls the hash operation so as to obtain a hash word element of the number of bits in accordance with the position of each of the plurality of word elements acquired by the word splitting unit 111. As an example, if the word encoding unit 112 calculates a hash word element of 5 bits with respect to each of the character strings of 3 characters, 3 characters, 3 characters, and the remaining characters, the word encoding unit 112 controls the hash operation so as to obtain the same hash functions. Then, for each of the character strings of 3 characters, 3 characters, 3 characters, and the remaining characters, the word encoding unit 112 calculates each of the hash word elements of 5 bits by using the controlled hash operation. The word encoding unit 112 combines each of the calculated hash word elements and creates a 20-bit integer as the encoding result.

The searching unit 113 searches the bit filter 121 for the word code associated with the search word. For example, the searching unit 113 compares the 20-bit integer in the bit filter 121 with the 20-bit integer that has been encoded by the word encoding unit 112. The searching unit 113 acquires a bit filter associated with the matched 20-bit integer. If the acquired bit filter is “Oh” that indicates the absence, the searching unit 113 outputs information indicating that the word is not present. If the acquired bit filter is “00001h” that indicates the presence, the searching unit 113 determines, by using the pointer to the acquired word, whether the character string in the search word is hit in the word character string. If character string in the search word is hit in the word character string, the searching unit 113 outputs the word code associated with the hit word character string. If the character string in the search word is not hit in the word character string, the searching unit 113 outputs information indicating that no hit occurs in the word character string.

Flow of the Search Process According to the First Embodiment

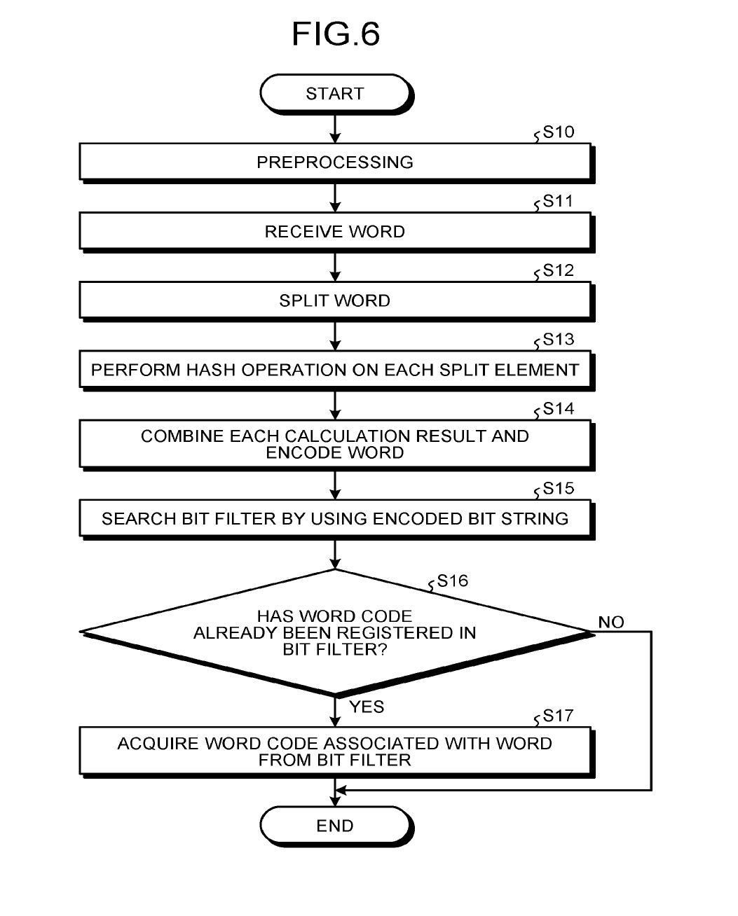

In the following, the flow of the search process according to the first embodiment will be described. FIG. 6 is a flowchart illustrating an example of the flow of the search process according to the first embodiment.

As illustrated in FIG. 6, the information processing apparatus 100 performs preprocessing (Step S10). For example, in the preprocessing, the information processing apparatus 100 ensures the area that holds the bit filter 121 and loads the bit filter 121 in the ensured area.

Then, the word splitting unit 111 receives a search word (Step S11). For example, the word splitting unit 111 may also extract a search word from a target file that includes therein the search word and receive the extracted search word. Furthermore, the word splitting unit 111 may also receive the search word from a keyboard that is an input device.

Then, the word splitting unit 111 splits the received search word (Step S12). For example, the word splitting unit 111 splits the received search word into every 3 bytes from the top and acquires a plurality of word elements.

Then, the word encoding unit 112 performs a hash operation on each of the split word elements (Step S13). For example, for each of the split word element, if the word encoding unit 112 calculates a hash word element of 5 bits, the word encoding unit 112 calculates each hash word element by using the same hash function.

Then, the word encoding unit 112 combines each of the calculation results and encodes the search word (Step S14). For example, the word encoding unit 112 combines each of the word element values obtained from the calculation and creates a 20-bit integer as the encoding result.

Then, the searching unit 113 searches the bit filter 121 by using the encoded bit string (Step S15). For example, the searching unit 113 compares the 20-bit integer in the bit filter 121 with the encoded 20-bit integer and acquires, on the basis of the comparison result, a bit filter that is associated with the matched 20-bit integer.

Then, the searching unit 113 determines whether the word code has already been registered in the bit filter 121 (Step S16). For example, the searching unit 113 determines whether the bit filter that is associated with the 20-bit integer included in the bit filter 121 is “00001h” that indicates the presence. If the bit filter associated with the 20-bit integer is “00001h”, the searching unit 113 determines, by using the pointer to the word, whether the character string in the search word is hit in the word character string.

If the searching unit 113 determines that the word code has not been registered in the bit filter 121 (No at Step S16), the searching unit 113 outputs information indicating that no hit occurs in the word character string. For example, if the bit filter associated with the 20-bit integer is not “00001h” that indicates the presence, the searching unit 113 outputs information indicating that no hit occurs in the word character string. Alternatively, if the bit filter associated with the 20-bit integer is “00001h” and the character string in the search word is not hit in the word character string, the searching unit 113 outputs information indicating that no hit occurs in the word character string. Then, the searching unit 113 ends the search process.

In contrast, if the searching unit 113 determines that the word code has already been registered in the bit filter 121 (Yes at Step S16), the searching unit 113 acquires the word code associated with the search word from the bit filter 121 (Step S17). Then, the searching unit 113 outputs the acquired word code and ends the search process.

### Advantage of the First Embodiment

According to the first embodiment, the information processing apparatus 100 splits a word targeted for a search (search word) and obtains a plurality of word elements. When the information processing apparatus 100 obtains a hash word element by hashing each of the word elements, the information processing apparatus 100 controls the hash operation so as to obtain the hash word elements of the number of bits that are in accordance with the respective positions of the word elements in the search word. The information processing apparatus 100 outputs, as the encoding result, a combination of each of the hash word elements of each of the word elements obtained from the hash operation. With this configuration, by encoding a word into a combination of each of the hash word elements of word elements obtained from the splitting, the information processing apparatus 100 can improve the search speed when a batch search is performed on a word targeted for the search.

### [b] Second Embodiment

The information processing apparatus 100 according to the first embodiment splits a search word and controls the hash operation so as to obtain hash word elements of the same number of bits for the word elements that are obtained from the split. Then, the information processing apparatus 100 outputs the combination of each of the hash word elements as the encoding result. However, the information processing apparatus 100 is not limited thereto but may also split a search word and control the hash operation so as to obtain, for the plurality of word elements obtained from the split, a hash word element of a larger number of bits as the position of the word element in a search word is closer to the forefront. In a dictionary, such as an English-Japanese dictionary, for the top three characters in an English word, the interval of the character strings becomes dense (a lot of similar character strings are present). Then, as the position of an word element is away from the top of an English word, the interval of the character strings becomes sparse. Accordingly, the hash operation is controlled such that, for a portion in which the interval of the character strings is dense, a hash word element of the number of bits larger than that of the other portions can be obtained and, for a portion in which the interval of the character strings is sparse, a hash word element of a small number of bits can be obtained. If a hash word element of a large number of bits is obtained for a portion in which the interval of the character strings is dense, even if the position is the same as that of the other words, the hash word element is not overlapped with the different characters as much as possible (guarantee the independence of a hash). Consequently, it is possible to easily distinguish a word from the other words.

Thus, in a second embodiment, a description will be given of a case in which the information processing apparatus 100 splits a search word and controls the hash operation so as to obtain a hash word element of a large number of bits as the position of an word element is closer to the forefront in the search word from among the plurality of word elements obtained as the result of split.

Search Process According to the Second Embodiment

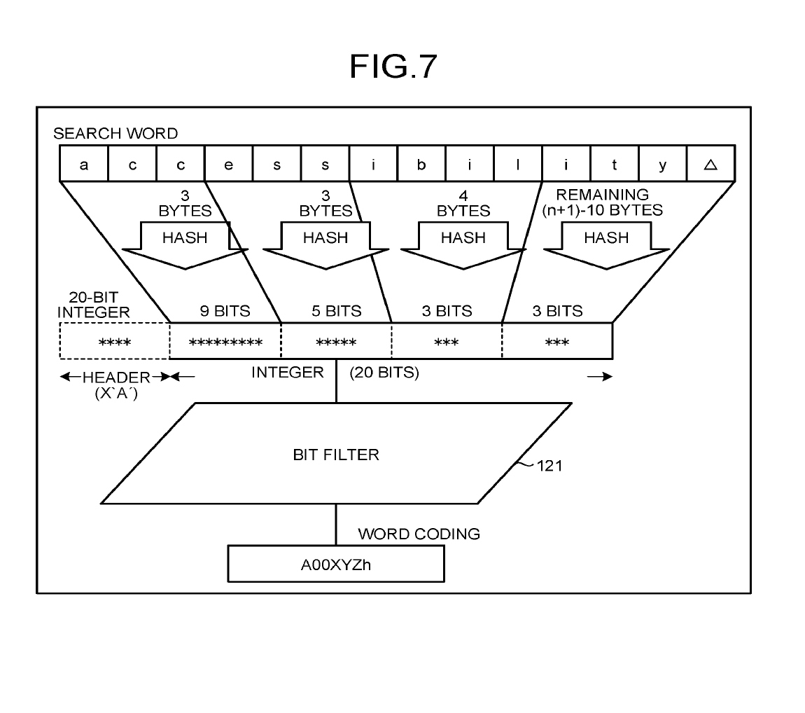

The search process according to the second embodiment will be described with reference to FIG. 7. FIG. 7 is a schematic diagram illustrating an example of a search process according to a second embodiment. As illustrated in FIG. 7, the information processing apparatus 100 splits “accessibilityΔ” included in the word targeted for the search (search word) into 3 bytes, 3 bytes, 4 bytes, and the remaining bytes, such as “acc”, “ess”, “ibil”, and “ityΔ”.

The information processing apparatus 100 controls the hash operation so as to obtain hash word elements of the number of bits in accordance with the respective positions, in a search word, of the plurality of word elements of “acc”, “ess”, “ibil”, and “ityΔ” obtained as the result of the split. The control of the hash operation mentioned here indicates a change in the number of bits to be output in accordance with the split position in the search word or a change in hash functions in accordance with the split position in the search word. For example, the information processing apparatus 100 controls the hash operation so as to obtain a hash word element of 9 bits in accordance with the position of the forefront word element “acc” in the search word. The information processing apparatus 100 controls the hash operation so as to obtain a hash word element of 5 bits in accordance with the position of the second word element “ess” in the search word. The information processing apparatus 100 controls the hash operation so as to obtain a hash word element of 3 bits in accordance with the position of the subsequent word element “ibil” in the search word. The information processing apparatus 100 controls the hash operation so as to obtain a hash word element of 3 bits in accordance with the position of the remaining word element “ityΔ” in the search word. Namely, the information processing apparatus 100 controls the hash operation so as to obtain a hash word element of a large number of bits as the position of the word element in the search word is closer to the forefront. In other words, the information processing apparatus 100 performs the control so as to obtain a hash word element of a large number of bits for the top 3 bytes that is the portion in which the interval of the character strings is dense. For the rear 4 bytes and the remaining bytes that are assumed to be a portion in which the interval of character strings is sparse, the information processing apparatus 100 performs the control so as to obtain a hash word element of a small number of bits in order to save the number of bits.

For each of the plurality of the word elements, the information processing apparatus 100 combines each of the hash word elements obtained from the hash operation and creates a 20-bit integer as the encoding result. Namely, the information processing apparatus 100 creates a 20-bit integer on the basis of the hash word element from the character string of n+1 grams that constitutes the search word. In the example illustrated in FIG. 7, n+1 is a value obtained by adding “13”, which is the character string length of the character string constituting the search word, to “1”, which is the length of the space that indicates the termination, and “14” is obtained.

Then, the information processing apparatus 100 outputs the 20-bit integer that is created as the encoding result to the bit filter 121. The information processing apparatus 100 compares the bit filter 121 with the 20-bit integer and determines whether the character string in the search word is hit in the bit filter 121.

Namely, the information processing apparatus 100 compares the bit filter 121 with the 20-bit integer that is created as the encoding result and acquires the bit filter that is associated with the 20-bit integer. The information processing apparatus 100 determines, by using the bit filter, whether a hit occurs in the word character string “accessibility”. Furthermore, the bit filter in the bit filter 121 indicates the presence or absence of the word character string that is associated with the “20-bit integer”. Namely, the bit filter in the bit filter 121 indicates the presence or absence of the word character string associated with the “20-bit integer” that is obtained when the word is encoded by using the same method as that used to encode the search word to the 20-bit integer.

If the character string in the search word is hit in the word character string, the information processing apparatus 100 outputs the word code associated with the word character string. In the example illustrated in FIG. 7, because the character string in the search word is hit in the word character string “accessibility”, the information processing apparatus 100 outputs the word code “A00XYZh” that is associated with the word character string “accessibility”.

Functional Configuration of the Information Processing Apparatus According to the Second Embodiment

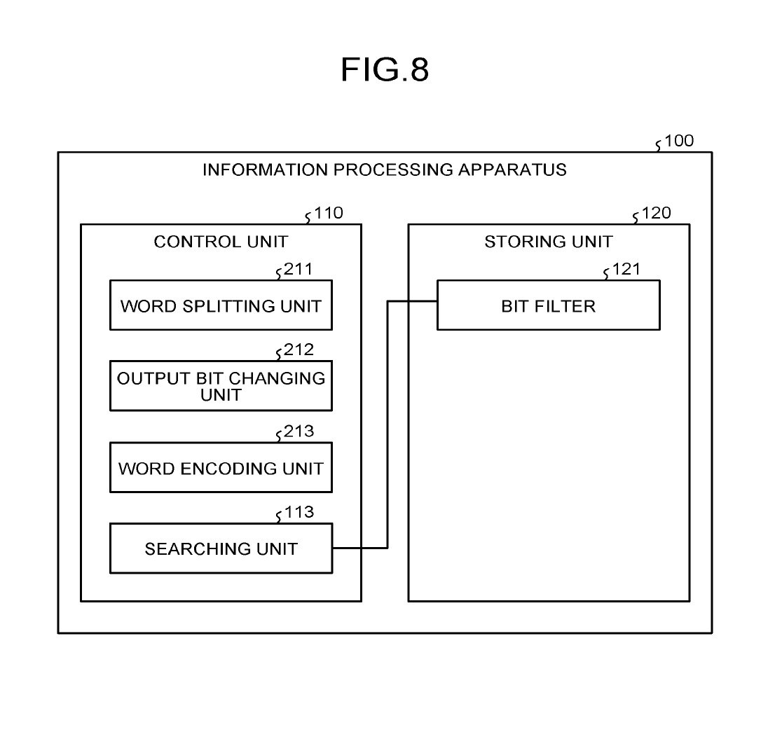

In the following, the functional configuration of the information processing apparatus 100 that executes a search process according to the second embodiment will be described with reference to FIG. 8. FIG. 8 is a schematic diagram illustrating the functional configuration of an information processing apparatus according to a second embodiment. By assigning the same reference numerals to components having the same configuration as those in the information processing apparatus 100 illustrated in FIG. 5, overlapped descriptions thereof will be omitted. The second embodiment differs from the first embodiment in that the word splitting unit 111 is changed to a word splitting unit 211 and the word encoding unit 112 is changed to a word encoding unit 213. Furthermore, the second embodiment differs from the first embodiment in that an output bit changing unit 212 is added.

The word splitting unit 211 splits a word targeted for a search (search word). For example, when the word splitting unit 211 acquires the search word, the word splitting unit 211 splits the acquired search word into, from the top, 3 bytes, 3 bytes, 4 bytes, and the remaining bytes. The word splitting unit 211 acquires a plurality of word elements that are obtained as the result of the split.

The output bit changing unit 212 changes the number of output bits of the word elements that are obtained by splitting the search word. For example, in accordance with the position of each of the plurality of the word elements acquired by the word splitting unit 211, the output bit changing unit 212 changes the number of bits of the hash word elements to be output. Namely, the output bit changing unit 212 changes the number of output bits so as to obtain a hash word element of a large number of bits as the position of the word element in the search word is closer to the forefront. As an example, in a case of the forefront word element in the search word, the number of output bits is set to 9 bits and, in a case of the subsequent word elements, the number of output bits is set to 5 bits, 3 bits, and 3 bits.

The word encoding unit 213 encodes, to 20 bits by hashing, the plurality of word elements obtained by splitting the search word. For example, the word encoding unit 213 controls the hash operation so as to obtain hash word elements of the number of output bits in accordance with each of the positions of the plurality of word elements acquired by the word splitting unit 211. The number of output bits in accordance with each of the positions is changed by the output bit changing unit 212. As an example, if the number of output bits of the forefront word element from among the plurality of word elements in the search word is 9 bits, the word encoding unit 213 calculates a hash word element by using a hash function in which the hash word element of 9 bits can be obtained. If the number of output bits of the subsequent word element from among the plurality of word elements in the search word is 5 bits, the word encoding unit 213 calculates a hash word element by using a hash function in which the hash word element of 5 bits can be obtained. If the number of output bits of the subsequent word element from among the plurality of word elements in the search word is 5 bits, the word encoding unit 213 calculates a hash word element by using a hash function in which the hash word element of 5 bits can be obtained. If the number of output bits of the last word element from among the plurality of word elements in the search word is 3 bits, the word encoding unit 213 calculates a hash word element by using a hash function in which the hash word element of 3 bits can be obtained. Then, the word encoding unit 213 combines each of the hash word elements obtained from the calculation and creates a 20-bit integer as the encoding result.

Flow of the Search Process According to the Second Embodiment

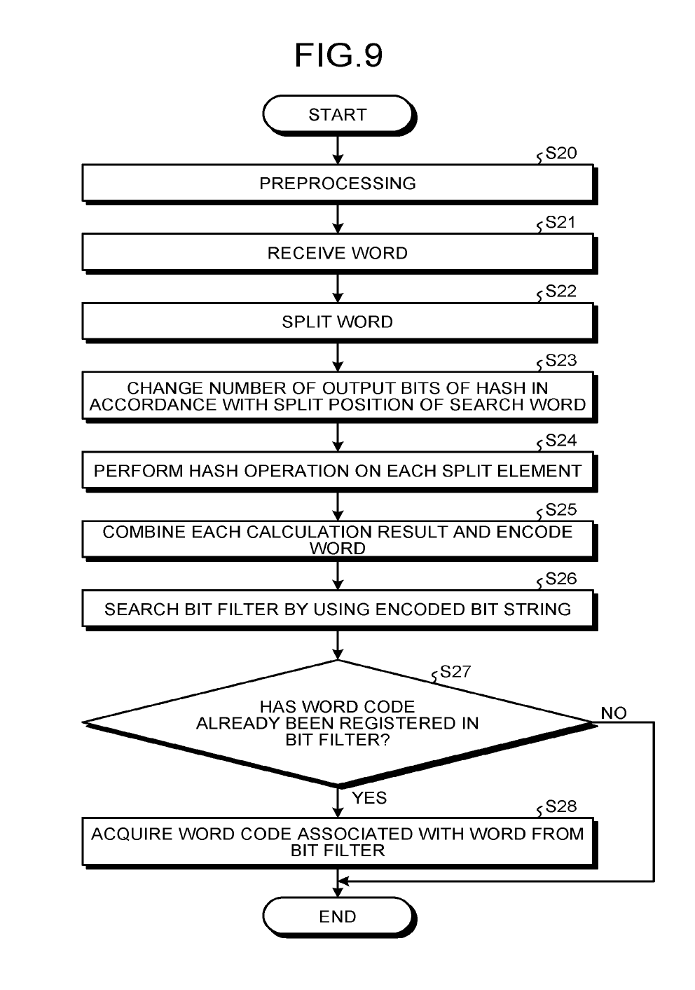

In the following, the flow of the search process according to the second embodiment will be described. FIG. 9 is a flowchart illustrating an example of the flow of the search process according to the second embodiment.

As illustrated in FIG. 9, the information processing apparatus 100 performs preprocessing (Step S20). For example, in the preprocessing, the information processing apparatus 100 ensures the area that holds the bit filter 121 and loads the bit filter 121 in the ensured area.

Then, the word splitting unit 211 receives a search word (Step S21). For example, the word splitting unit 211 may also extract a search word from a target file that includes therein the search word and receive the extracted search word. Furthermore, the word splitting unit 211 may also receive the search word from a keyboard that is an input device.

Then, the word splitting unit 211 splits the received search word (Step S22). As an example, the word splitting unit 211 splits the received search word into, from the top, 3 bytes, 3 bytes, 4 bytes, and the remaining byte and acquires a plurality of word elements.

Then, the output bit changing unit 212 changes the number of output bits of the hash in accordance with the split position of the search word (Step S23). As an example, for the word element with 3 bytes from the top in the search word, the output bit changing unit 212 changes the number of output bits for the hash to 9 bits. For the subsequent word element with 3 bytes in the search word, the output bit changing unit 212 changes the number of output bits for the hash to 5 bits. For the subsequent word element with 4 bytes in the search word, the output bit changing unit 212 changes the number of output bits for the hash to 3 bits. For the last word element with the remaining bytes in the search word, the output bit changing unit 212 changes the number of output bits for the hash to 3 bits.

Then, the word encoding unit 213 performs the hash operation on each of the split word elements (Step S24). For example, for each of the split word elements, the word encoding unit 213 calculates a hash word element by using a hash function in which a hash word element of the changed output bits can be obtained. As an example, for the forefront word element in the search word, the word encoding unit 213 calculates a hash word element by using a hash function in which a hash word element of 9 bits can be obtained. For the subsequent word element in the search word, the word encoding unit 213 calculates a hash word element by using a hash function in which a hash word element of 5 bits can be obtained. For the subsequent word element in the search word, the word encoding unit 213 calculates a hash word element by using a hash function in which a hash word element of 3 bits can be obtained. For the last word element in the search word, the word encoding unit 213 calculates a hash word element by using a hash function in which a hash word element of 3 bits can be obtained.

Then, the word encoding unit 213 combines each of the calculation results and encodes the search word (Step S25). For example, the word encoding unit 213 combines each of the hash word elements obtained from the calculation and creates a 20-bit integer as the encoding result.

Then, the searching unit 113 searches the bit filter 121 by using the encoded bit string (Step S26). For example, the searching unit 113 compares the 20-bit integer in the bit filter 121 with the encoded 20-bit integer and acquires, on the basis of the result of the comparison, the bit filter that is associated with the matched 20-bit integer.

Then, the searching unit 113 determines whether the word code has already been registered in the bit filter 121 (Step S27). For example, the searching unit 113 determines whether the bit filter associated with the 20-bit integer that is included in the bit filter 121 is “00001h” that indicates the presence. If the bit filter associated with the 20-bit integer is “00001h”, the searching unit 113 determines, by using the pointer to the word, whether the character string in the search word is hit in the word character string.

If the searching unit 113 determines that the word code has not been registered in the bit filter 121 (No at Step S27), the searching unit 113 outputs information indicating that no hit occurs in the word character string. For example, if the bit filter associated with the 20-bit integer is not “00001h” that indicates the presence, the searching unit 113 outputs information indicating that no hit occurs in the word character string. Alternatively, if the bit filter associated with the 20-bit integer is “00001h” and the character string in the search word is not hit in the word character string, the searching unit 113 outputs information indicating that no hit occurs in the word character string. Then, the searching unit 113 ends the search process.

In contrast, if the searching unit 113 determines that the word code has already been registered in the bit filter 121 (Yes at Step S27), the searching unit 113 acquires the word code associated with the search word from the bit filter 121 (Step S28). Then, the searching unit 113 outputs the acquired word code and ends the search process.

Specific Example of a Word Encoding Process

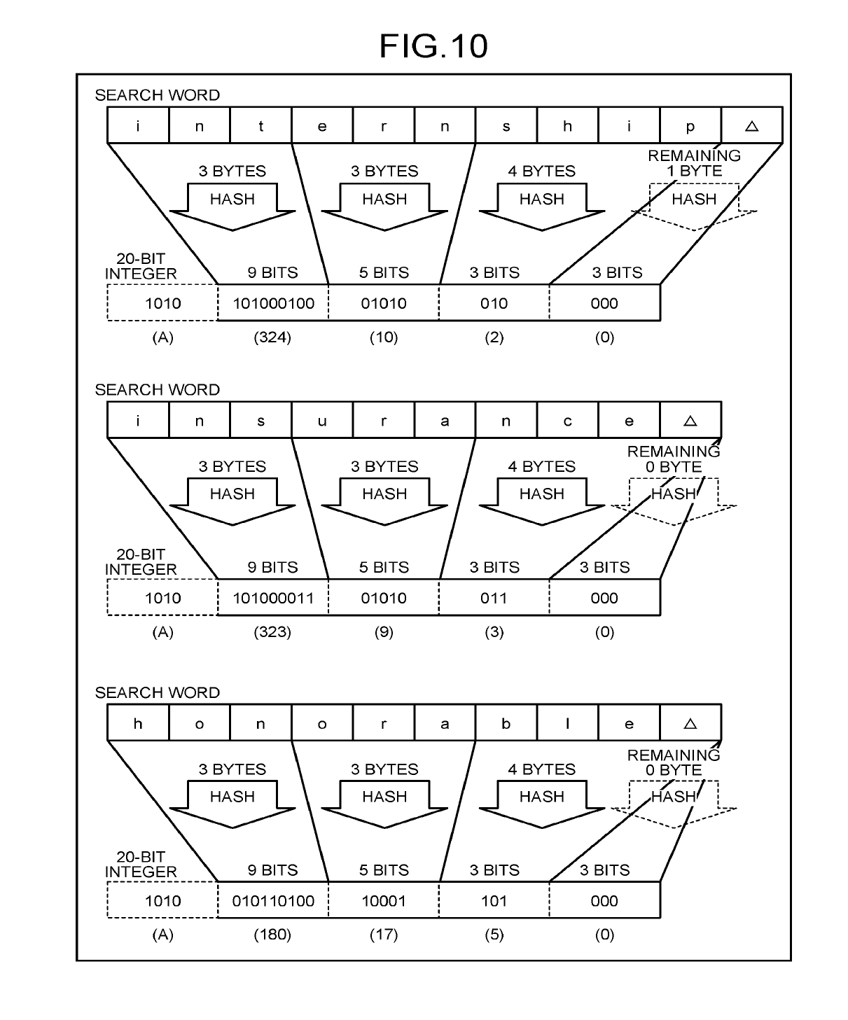

FIG. 10 is a schematic diagram illustrating a specific example of a word encoding process according to the second embodiment. As illustrated in FIG. 10, in the upper position, if a search word is “internshipΔ”, the search word is encoded to a 20-bit integer.

Specifically, the word splitting unit 211 splits the search word “internshipΔ” into, from the top, “int” of 3 bytes, “ern” of 3 bytes, “ship” of 4 bytes, and “Δ” of the remaining 1 byte.

Then, for “int” of 3 bytes at the top position in the search word, the output bit changing unit 212 changes the number of output bits for the hash to 9 bits. For “ern” of 3 bytes at the subsequent position in the search word, the output bit changing unit 212 changes the number of output bits for the hash to 5 bits. For “ship” of 4 bytes at the subsequent position in the search word, the output bit changing unit 212 changes the number of output bits for the hash to 3 bits. For “Δ” of the remaining byte at the last position in the search word, the output bit changing unit 212 changes the number of output bits for the hash to 3 bits.

Then, for “int” at the forefront position in the search word, the word encoding unit 213 calculates a hash word element by using a hash function in which the hash word element of 9 bits can be obtained. Consequently, “101000100b” (decimal number: 324) is calculated as a hash word element. For “ern” that is at the subsequent position in the search word, the word encoding unit 213 calculates a hash word element by using a hash function in which the hash word element of 5 bits can be obtained. Consequently, “01010b” (decimal number: 10) is calculated as a hash word element. For “ship” at the subsequent position in the search word, the word encoding unit 213 calculates a hash word element by using a hash function in which the hash word element of 3 bits can be obtained. Consequently, “010b” (decimal number: 2) can be calculated as the hash word element. For “Δ” at the last position in the search word, the word encoding unit 213 calculates a hash word element by using a hash function in which the hash word element of 3 bits can be obtained. Consequently, “000b” (decimal number: 0) is calculated as the hash word element.

In the middle portion, if a search word is “insuranceΔ”, the search word is encoded to a 20-bit integer. In the lower portion, if a search word is “honorableΔ”, the search word is encoded to a 20-bit integer.

Specifically, for “ins” at the forefront position in the search word, the word encoding unit 213 calculates a hash word element by using a hash function in which the hash word element of 9 bits can be obtained. Consequently, “101000011b” (decimal number: 323) is calculated as the hash word element. For “ura” at the subsequent position in the search word, the word encoding unit 213 calculates a hash word element by using a hash function in which the hash word element of 5 bits can be obtained. Consequently, “01010b” (decimal number: 9) is calculated as the hash word element. For “nceΔ” at the subsequent position in the search word, the word encoding unit 213 calculates a hash word element by using a hash function in which the hash word element of 3 bits can be obtained. Consequently, “011b” (decimal number: 3) is calculated as the hash word element. Because the last portion is not present in the search word, the word encoding unit 213 sets “000b” (decimal number: 0) as the hash word element of 3 bits.

In the lower portion, if a search word is “honorableΔ”, the search word is encoded to a 20-bit integer.

Specifically, for “hon” at the forefront position in the search word, the word encoding unit 213 calculates a hash word element by using a hash function in which the hash word element of 9 bits can be obtained. Consequently, “010110100b” (decimal number: 180) is calculated as the hash word element. For “ora” at the subsequent position in the search word, the word encoding unit 213 calculates a hash word element by using a hash function in which the hash word element of 5 bits can be obtained. Consequently, “10001b” (decimal number: 17) is calculated as the hash word element. For “bled” at the subsequent position in the search word, the word encoding unit 213 calculates a hash word element by using a hash function in which the hash word element of 3 bits can be obtained. Consequently, “101b” (decimal number: 5) is calculated as the hash word element. Because the last portion is not present in the search word, the word encoding unit 213 sets “000b” (decimal number: 0) as the hash word element of 3 bits.

In this way, by allocating a hash function that has a hash word element having a large number of digits as much as possible to the forefront word element in which the interval of character strings is dense from among the plurality of word elements in the search word, the word encoding unit 213 can perform the match determination at a high speed in a portion in which the interval of character strings is dense. Namely, the searching unit 113 can narrow down, at the forefront 9 bits of the 20-bit integer created by the word encoding unit 213, the 20-bit integers in the bit filter 121 and speed up a search of the 20-bit integer that is associated with the search word.

### Advantage of the Second Embodiment

According to the second embodiment described above, the information processing apparatus 100 splits a word targeted for a search (search word) and obtains a plurality of word elements. When the information processing apparatus 100 obtains a hash word element by hashing each of the word elements, the information processing apparatus 100 controls the hash operation so as to obtain a hash word element of a large number of bits as the position of the word element in the search word is closer to the forefront portion in the search word. The information processing apparatus 100 outputs, as the encoding result, a combination of each of the hash word elements obtained from the plurality of word elements by the hash operation. With this configuration, because the information processing apparatus 100 outputs an encoding result that includes therein a hash word element of a large number of bits as the position of the word element in the search word is closer to the forefront in the search word, it is possible to improve the speed when a batch search is performed on the encoding result.

### [c] Third Embodiment

The information processing apparatus 100 according to the second embodiment splits a search word and controls the hash operation so as to obtain, for the plurality of word elements obtained as the result of the split, a hash word element of a larger number of bits as the position of the word element in the search word is closer to the forefront. Then, the information processing apparatus 100 outputs a combination of each of the hash word elements as the encoding result. However, the information processing apparatus 100 is not limited thereto but may also perform, for the plurality of word elements obtained as the result of the split, if the position of the word element in the search word is the forefront, control so as to obtain values associated with character string distribution. In a dictionary, such as an English-Japanese dictionary, the interval of character strings becomes dense (a lot of similar character strings are present) for the first three characters in an English word. Furthermore, the interval of character strings becomes sparse as the position is away from the top of the English word. Accordingly, for the portion in which the interval of character strings is dense, instead of the hash word element of the number of bits larger than that of the other portions, by setting values that are associated with the character string distribution, it is possible to easily distinguish a word from the other words with higher accuracy.

Thus, in a third embodiment, a description will be given of a case in which the information processing apparatus 100 splits a search word and performs control, if the position of the word element in the search word from among the plurality of word elements obtained from the split, so as to obtain values fitted to the character string distribution.

Search Process According to the Third Embodiment

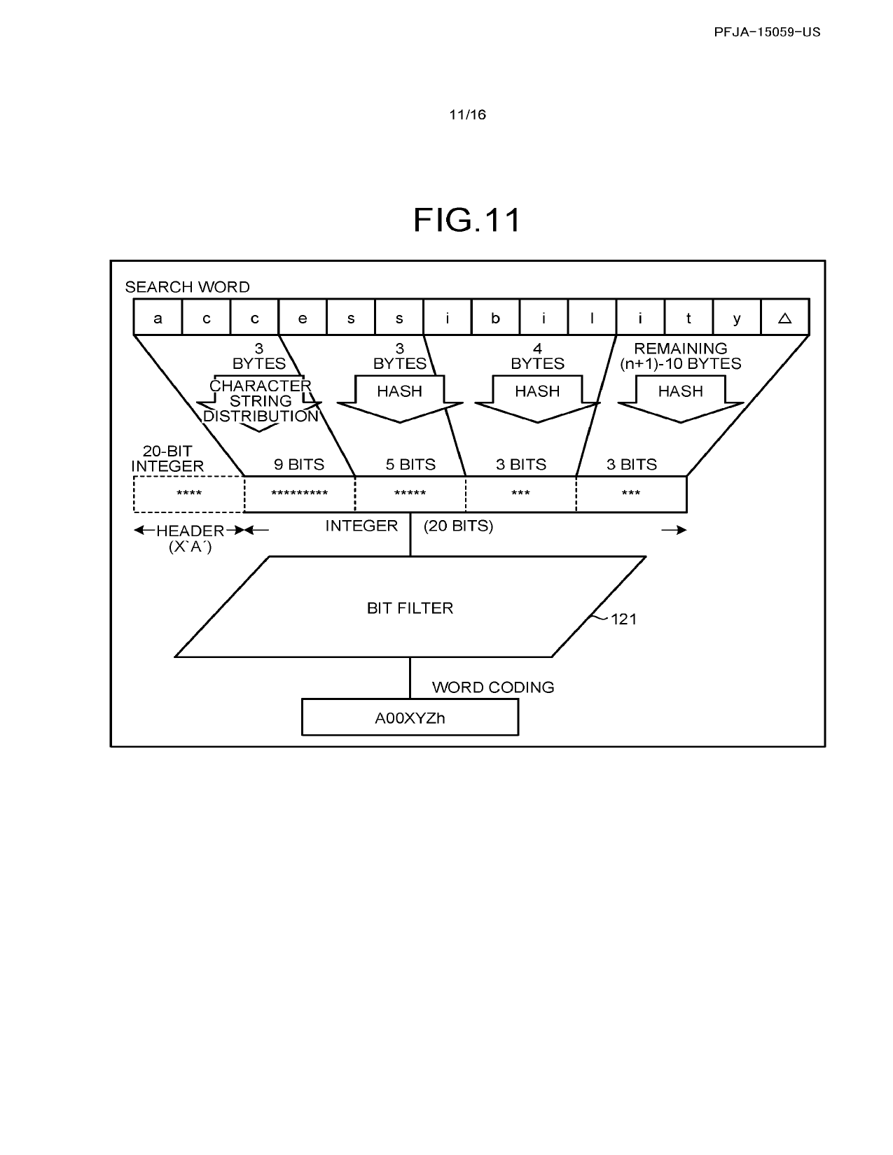

The search process according to the third embodiment will be described with reference to FIG. 11. As illustrated in FIG. 11, the information processing apparatus 100 splits “accessibilityΔ” included in a word targeted for a search (search word) into 3 bytes, 3 bytes, 4 bytes, and the remaining bytes, such as “acc”, “ess”, “ibil”, and “ityΔ”.

For the forefront word element “acc” from among the plurality of word elements obtained from the split, the information processing apparatus 100 performs control so as to obtain values fitted to the character string distribution. The character string distribution mentioned here is the association portion of a word code that is associated with the character string with 3 grams at the top in the word and is information on the character string distribution with top 9 bits in the word code.

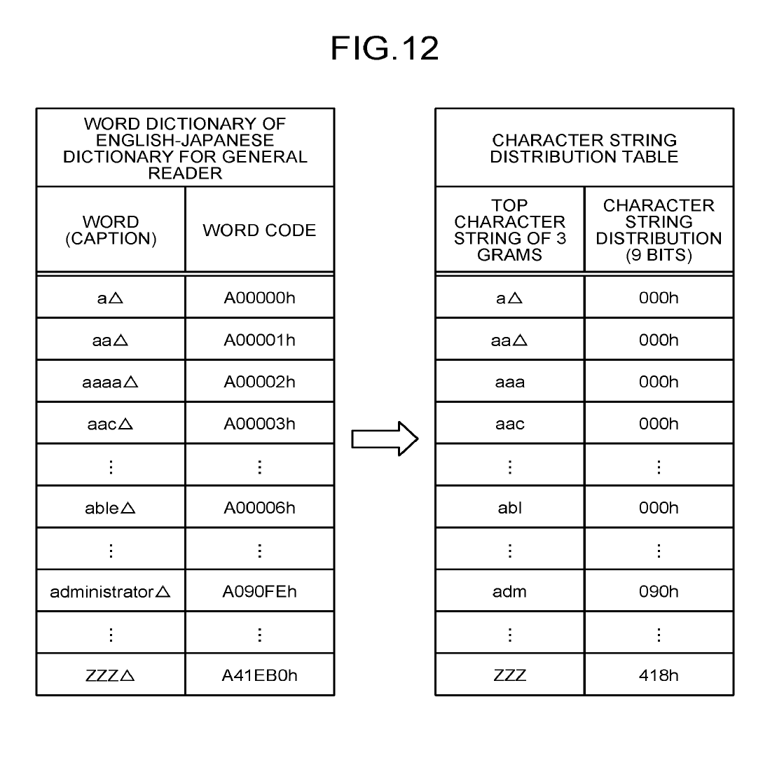

In the following, the character string distribution will be described with reference to FIG. 12. FIG. 12 is a schematic diagram illustrating character string distribution.

The left portion illustrated in FIG. 12 indicates the association relationship between the English words stored in the word dictionary of the English-Japanese Dictionary for the General Reader and the word codes. The word codes associated with the English words are represented by 3 bytes, such as A00000h to AFFFFFh. The top 4 bits is a header that indicates the word is an English word and is represented by the hexadecimal number “A”. As an example, the word code associated with the word “aΔ” is “A00000h”. The word code associated with word “ableΔ” is “A00006h”. The word code associated with the word “administratorΔ” is “A090FEh”. The character string distribution table is previously created from the word dictionary of the English-Japanese Dictionary for the General Reader.

The right portion illustrated in FIG. 12 indicates a character string distribution table. The character string distribution table associates the top character string of 3 grams of the character string distribution (9 bits). The top character string of 3 grams mentioned here is the top character string of 3 grams in a word in a word dictionary of the English-Japanese Dictionary for the General Reader. The character string distribution (9 bits) mentioned here is the top 9 bits except for the header of the word codes associated with the word. Namely, for the character string of the top 3 grams in a word, the character string distribution (9 bits) extracts the high order 9 bits in the word code associated with the word. Hereinafter, the character string distribution (9 bits) is referred to as the character string distribution. As an example, the character string distribution associated with the top character string “aΔ” of 3 grams is “000h”. The character string distribution associated with the top character string “abl” of 3 grams is “000h”. The character string distribution associated with the top character string “adm” of 3 grams is “090h”. For example, the information processing apparatus 100 acquires the character string distribution associated of the top 3 grams of the word from the character string distribution table as the value of the top 3 grams of the word that is fitted to the character string distribution.

A description will be given here by referring back to FIG. 11. For example, the information processing apparatus 100 acquires, from the character string distribution table, the character string distribution of 9 bits that is associated with the top word element “acc” as the value in which the top word element “acc” from among the plurality of word elements is associated with the character string distribution. Namely, the information processing apparatus 100 performs control so as to fit the top 3 bytes that is the portion in which the interval of character strings is dense to the distribution in the dictionary.

For the word elements “ess”, “ibil”, and “lityΔ” that are other than the top word element from among the plurality of word elements obtained from the split, the information processing apparatus 100 controls the hash operation so as to obtain the hash word elements with the number of bits in accordance with the positions in the search word. The control of the hash operation mentioned here indicates a change in the number of output bits in accordance with the split positions in the search word or a change in hash functions in accordance with the split positions in the search word. For example, the information processing apparatus 100 controls the hash operation so as to obtain a hash word element of 5 bits in accordance with the position of the word element “ess” in the search word. The information processing apparatus 100 controls the hash operation so as to obtain a hash word element of 3 bits in accordance with the subsequent word element “ibil” in the search word. The information processing apparatus 100 controls the hash operation so as to obtain a hash word element of 3 bits in accordance with the position of the remaining word element “ityΔ” in the search word. Namely, for the 3 bytes that is closer to the top that is a portion in which the interval of character strings is dense, the information processing apparatus 100 performs the control so as to obtain a hash word element of a larger number of bits. In contrast, for the rear 4 bytes and the remaining bytes that are assumed to be a portion in which the interval of character strings is sparse, the information processing apparatus 100 performs the control so as to obtain a hash word element of a small number of bits in order to save the number of bits.

For each of the plurality of the word elements, the information processing apparatus 100 combines each of the hash word elements obtained from the hash operation and creates a 20-bit integer as the encoding result. Namely, the information processing apparatus 100 creates a 20-bit integer on the basis of the hash word element from the character string of n+1 grams that constitutes the search word. In the example illustrated in FIG. 11, n+1 is a value obtained by adding “13”, which is the character string length of the character string constituting the search word, to “1”, which is the length of the space that indicates the termination, and “14” is obtained.

Then, the information processing apparatus 100 outputs the 20-bit integer that is created as the encoding result to the bit filter 121. The information processing apparatus 100 compares the bit filter 121 with the 20-bit integer and determines whether the character string in the search word is hit in the bit filter 121.

Namely, the information processing apparatus 100 compares the bit filter 121 with the 20-bit integer that is created as the encoding result and acquires the bit filter that is associated with the 20-bit integer. The information processing apparatus 100 determines, by using the bit filter 121, whether a hit occurs in the word character string “accessibility”. Furthermore, the bit filter in the bit filter 121 indicates the presence or absence of the word character string that is associated with the “20-bit integer”. Namely, the bit filter in the bit filter 121 indicates the presence or absence of the word character string associated with the “20-bit integer” that is obtained when the word is encoded by using the same method as that used to encode the search word to the 20-bit integer.

If the character string in the search word is hit in the word character string, the information processing apparatus 100 outputs the word code associated with the word character string. In the example illustrated in FIG. 11, because the character string in the search word is hit in the word character string “accessibility”, the information processing apparatus 100 outputs the word code “A00XYZh” that is associated with the word character string “accessibility”.

Functional Configuration of the Information Processing Apparatus According to the Third Embodiment

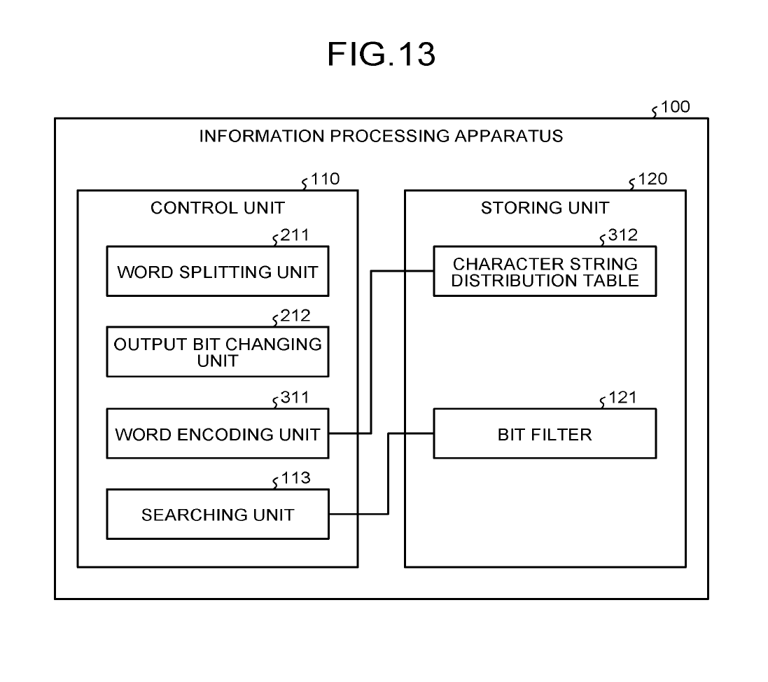

In the following, the functional configuration of the information processing apparatus 100 that performs a search process according to the third embodiment will be described with reference to FIG. 13. FIG. 13 is a schematic diagram illustrating the functional configuration of an information processing apparatus according to a third embodiment. By assigning the same reference numerals to components having the same configuration as those in the information processing apparatus 100 illustrated in FIG. 8, overlapped descriptions thereof will be omitted. The third embodiment differs from the second embodiment in that the word encoding unit 213 is changed to a word encoding unit 311. The third embodiment differs from the second embodiment in that a character string distribution table 312 is added.

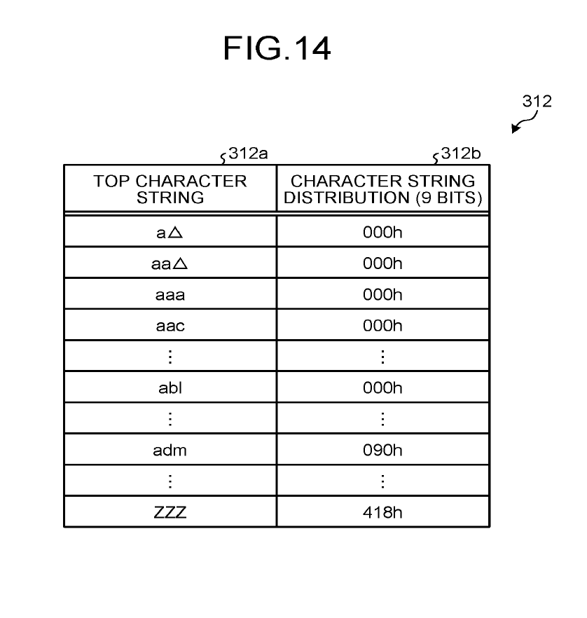

In the following, the data structure of the character string distribution table 312 will be described with reference to FIG. 14. FIG. 14 is a schematic diagram illustrating an example of the data structure of a character string distribution table according to the third embodiment. As illustrated in FIG. 14, the character string distribution table 312 stores therein, in an associated manner, a top character string 312a and a character string distribution (9 bits) 312b. The top character string 312a indicates the character string of the top 3 grams in a word. The character string distribution (9 bits) 312b indicates the top 9 bits except for the header in the word code that is associated with the word.

The word encoding unit 311 encodes the plurality of word elements split from the search word to 20 bits by using the character string distribution and hashing.

For example, the word encoding unit 311 acquires, from the character string distribution table 312, the character string distribution that is associated with the top word element from among the plurality of word elements acquired by the word splitting unit 211. Namely, the word encoding unit 311 acquires, from the character string distribution table 312, the character string distribution (9 bits) 312b that is associated with the top character string of 3 bytes that is the top word element. Namely, the word encoding unit 311 performs control such that the top word element is fitted to the distribution in the dictionary.

Furthermore, for the word elements other than the top word element from among the plurality of word elements acquired by the word splitting unit 211, the word encoding unit 311 controls the hash operation so as to obtain a hash word element of the number of output bits in accordance with each position. The number of output bits in accordance with each position is changed by the output bit changing unit 212.

Furthermore, the word encoding unit 311 combines the acquired character string distribution with each of the hash word elements obtained from the calculation and creates a 20-bit integer as the encoding result.

Flow of a Search Process According to the Third Embodiment

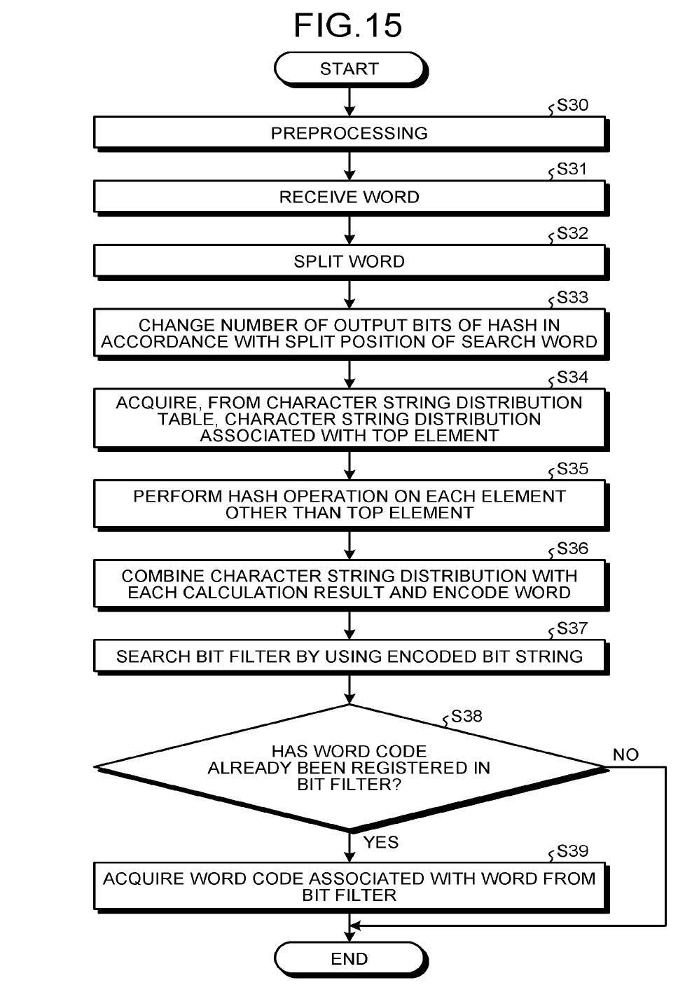

In the following, the flow of a search process according to the third embodiment will be described. FIG. 15 is a flowchart illustrating an example of the flow of a search process according to the third embodiment.

As illustrated in FIG. 15, the information processing apparatus 100 performs preprocessing (Step S30). For example, in the preprocessing, the information processing apparatus 100 ensures the area that holds therein the bit filter 121 and ensures the area that holds therein the character string distribution table 312. Then, the information processing apparatus 100 loads the bit filter 121 and the character string distribution table 312 in the ensured area.

Then, the word splitting unit 211 receives a search word (Step S31). For example, the word splitting unit 211 may also extract a search word from a target file that includes therein the search word and receive the extracted search word. Furthermore, the word splitting unit 211 may also receive the search word from a keyboard that is an input device.

Then, the word splitting unit 211 splits the received search word (Step S32). As an example, the word splitting unit 211 splits the received search word into, from the top, 3 bytes, 3 bytes, 4 bytes, and the remaining byte and acquires a plurality of word elements.

Then, the output bit changing unit 212 changes the number of output bits of the hash in accordance with the split position in the search word (Step S33). As an example, the output bit changing unit 212 changes the number of output bits associated with the top word element from among the word elements that are split from the search word to 9 bits. Then, for the subsequent word element with 3 bytes in the search word, the output bit changing unit 212 changes the number of output bits for the hash to 5 bits. For the subsequent word element with 4 bytes in the search word, the output bit changing unit 212 changes the number of output bits for the hash to 3 bits. For the last word element with the remaining bytes in the search word, the output bit changing unit 212 changes the number of output bits for the hash to 3 bits.

Then, the word encoding unit 311 acquires, from the character string distribution table 312, character string distribution that is associated with the top word element (Step S34). For example, the word encoding unit 311 acquires, from the character string distribution table 312, the character string distribution (9 bits) 312b that is associated with the top character string of 3 bytes that is the top word element.

Then, the word encoding unit 311 performs the hash operation on each of the word elements other than the top word element (Step S35). For example, for each of the word elements other than the top word element, the word encoding unit 311 calculates a hash word element by using a hash function in which a hash word element of the changed output bits can be obtained. As an example, for the word element subsequent to the top word element in the search word, the word encoding unit 311 calculates a hash word element by using a hash function in which a hash word element of 5 bits can be obtained. For the subsequent word element in the search word, the word encoding unit 311 calculates a hash word element by using a hash function in which a hash word element of 3 bits can be obtained. For the last word element in the search word, the word encoding unit 311 calculates a hash word element by using a hash function in which a hash word element of 3 bits can be obtained.

Then, the word encoding unit 311 combines the character string distribution with each of the calculation results and encodes the search word (Step S36). For example, the word encoding unit 311 combines each of the word elements obtained from the calculation and creates a 20-bit integer as the encoding result.

Then, the searching unit 113 searches the bit filter 121 by using the encoded bit string (Step S37). For example, the searching unit 113 compares the 20-bit integer in the bit filter 121 with the encoded 20-bit integer and acquires, on the basis of the result of the comparison, the bit filter that is associated with the matched 20-bit integer.

Then, the searching unit 113 determines whether the word code has already been registered in the bit filter 121 (Step S38). For example, the searching unit 113 determines whether the bit filter associated with the 20-bit integer that is included in the bit filter 121 is “00001h” that indicates the presence. If the bit filter associated with the 20-bit integer is “00001h”, the searching unit 113 determines, by using the pointer to the word, whether the character string in the search word is hit in the word character string.

If the searching unit 113 determines that the word code has not been registered in the bit filter 121 (No at Step S38), the searching unit 113 outputs information indicating that no hit occurs in the word character string. For example, if the bit filter associated with the 20-bit integer is not “00001h” that indicates the presence, the searching unit 113 outputs information indicating that no hit occurs in the word character string. Alternatively, if the bit filter associated with the 20-bit integer is “00001h” and the character string in the search word is not hit in the word character string, the searching unit 113 outputs information indicating that no hit occurs in the word character string. Then, the searching unit 113 ends the search process.

In contrast, if the searching unit 113 determines that the word code has already been registered in the bit filter 121 (Yes at Step S38), the searching unit 113 acquires the word code associated with the search word from the bit filter 121 (Step S39). Then, the searching unit 113 outputs the acquired word code and ends the search process.

### Advantage of the Third Embodiment

According to the third embodiment described above, the information processing apparatus 100 splits a word targeted for a search (search word) and obtains a plurality of word elements. When the information processing apparatus 100 obtains a hash word element by hashing each of the word elements, the information processing apparatus 100 controls the hash operation so as to obtain a hash word element of a large number of bits as the position of the word element in the search word is closer to the forefront portion in the search word. In addition, if the position of the word element in the search word is the forefront in the search word, the information processing apparatus 100 performs control so as to obtain a value that is fit to the character string distribution. For each of the plurality of word elements, the information processing apparatus 100 outputs, as the encoding result, values that are fit to the character string distribution and a combination of each of the hash word elements obtained from the hash operation. With this configuration, because the information processing apparatus 100 outputs, an encoding result, a value that is obtained by fitting the forefront word element in the search word to the character string distribution, it is possible to further improve the speed when a batch search is performed on the encoding result.

Another Embodiment Related to the First to the Third Embodiments

In the following, a description will be given of a part of a modification according to the embodiments described above. In addition to the modification described below, design changes can be appropriately made without departing from the scope of the present invention.

Furthermore, a description has been given of a case in which the information processing apparatus 100 according to the first embodiment calculates a hash word element of 5 bits for each of the character strings of 3 characters, 3 characters, 3 characters, and the remaining characters that are a plurality of word elements split from the search word; however, the embodiment is not limited thereto. The information processing apparatus 100 may also calculate, by using the hash operation, a hash word element of 5 bits for each of the character strings of 2 characters, 2 characters, 2 characters, and the remaining characters. Alternatively, the information processing apparatus 100 may also calculate, by using the hash operation, a hash word element of 5 bits for each of the character strings of 4 characters, 4 characters, 4 characters, and the remaining characters. Namely, the information processing apparatus 100 may determine the size of the characters to be split in accordance with the words used in a dictionary and calculate each hash word element of 5 bits.

Furthermore, a description has been given of a case in which the information processing apparatus 100 according to the second and the third embodiments calculates, for character strings of 3 characters, 3 characters, 4 characters, and the remaining characters that corresponds to the plurality of word elements that are split from the search word, a character string distribution or a hash word element of 9 bits, 5 bits, 3 bits, and 3 bits; however, the embodiment is not limited thereto. The information processing apparatus 100 may also calculate a character string distribution or a hash word element of 9 bits, 5 bits, 3 bits, and 3 bits for each of the character strings of 2 characters, 3 characters, 4 characters, and the remaining characters. Namely, the information processing apparatus 100 determines the size of characters to be split in accordance with the words used in a dictionary and calculate a character string distribution or a hash word element of 9 bits, 5 bits, 3 bits, and 3 bits.

Furthermore, the flow of the processes, the control procedures, the specific names, and the information containing various kinds of data or parameters indicated in the first to the third embodiments can be arbitrarily changed unless otherwise stated.

Hardware Configuration of the Information Processing Apparatus

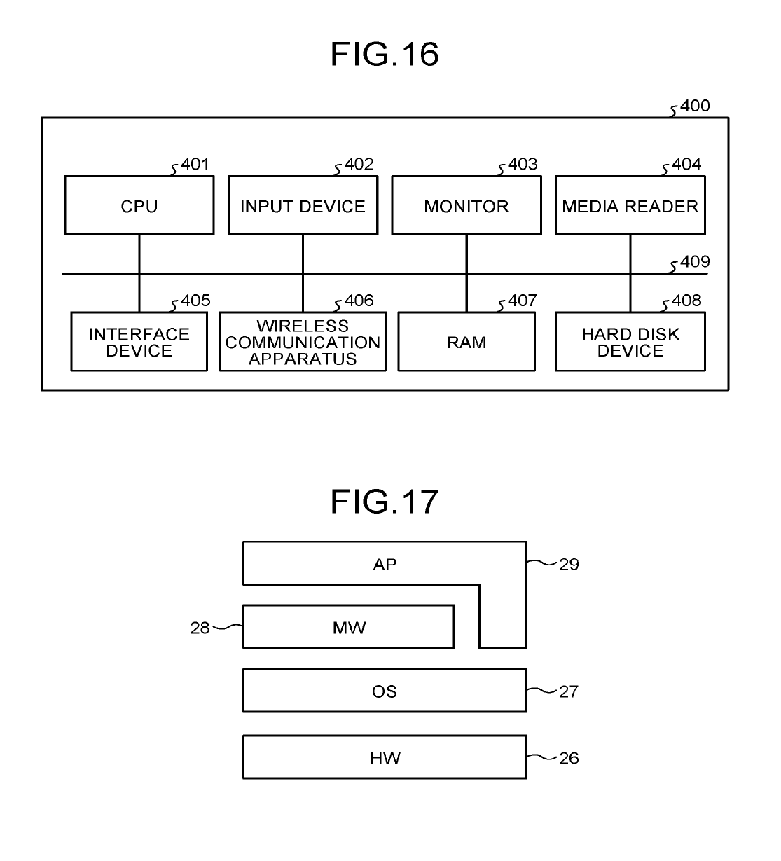

FIG. 16 is a block diagram illustrating the hardware configuration of the information processing apparatus according to the first to the third embodiments. As indicated by the example illustrated in FIG. 16, a computer 400 includes a CPU 401 that executes various kinds arithmetic processing, an input device 402 that receives an input of data from a user, and a monitor 403. Furthermore, the computer 400 includes a media reader 404 that reads a program or the like from a storage medium, an interface device 405 for connecting another device, and a wireless communication apparatus 406 that is used to wirelessly connect to the other device. Furthermore, the computer 400 includes a RAM 407 and a hard disk device 408 that temporarily store therein various kinds of information. Furthermore, each of the devices 401 to 408 is connected to a bus 409.

The hard disk device 408 stores therein a search program having the same function as that performed by each of the processing units, such as the word splitting unit 111, the word encoding unit 112, and the searching unit 113 illustrated in FIG. 5. Furthermore, the hard disk device 408 stores therein various kinds of data that implements the search program.

The CPU 401 reads each of the programs stored in the hard disk device 408 and loads the programs in the RAM 407, thereby performing various kinds of processes. These programs can allow the computer 400 to function as, for example, the word splitting unit 111, the word encoding unit 112, and the searching unit 113 illustrated in FIG. 5.

The search program described above is not always stored in the hard disk device 408. For example, the computer 400 may also read and execute programs stored in a storage medium that can be read by the computer 400. Examples of the recording medium that can be read by the computer 400 include a portable recording medium, such as a CD-ROM, a DVD disk, or a universal serial bus (USB) memory, a semiconductor memory, such as a flash memory, and a hard disk drive. Furthermore, the programs may also be stored in a device connected to, for example, a public circuit, the Internet, a local area network (LAN), or the like and the computer 400 may also read and execute the programs from the recording medium described above.

FIG. 17 is a schematic diagram illustrating an example of the configuration of a program running on a computer. In the computer 400, an operating system (OS) 27 that controls a hardware group 26 (401 to 409) illustrated in FIG. 17 is operated. The CPU 401 is operated in accordance with the procedure of the OS 27 and then control and management of the hardware group 26 is performed, whereby the processed in accordance with an application program 29 or middleware 28 are performed in the hardware group 26. Furthermore, in the computer 400, the middleware 28 or the application program 29 are read into the RAM 407 and executed by the CPU 401.

If a search word is received by the CPU 401, by performing processes on the basis of at least a part of the middleware 28 or the application program 29 (by controlling the hardware group 26 on the basis of the OS 27), the search function performed by the control unit 110 is implemented. The search function may also be included in the application program 29 itself or may be a part of the middleware 28 that is executed by being called in accordance with the application program 29.

According to an aspect of an embodiment of the present invention, an advantage is provided in that a search speed of an input character string can be improved while the size of hash data is reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an encoding program that causes a computer to execute a process comprising:
splitting a word to be encoded into a plurality of word elements;
obtaining a plurality of hashed word elements by hashing each of the plurality of word elements, number of bits of each of the plurality of hashed word elements corresponding to a position of each of the plurality of word elements in the word, respectively; and
outputting an encoding result that the plurality of the hashed word elements are combined.

2. The non-transitory computer-readable recording medium according to claim 1, wherein the obtaining includes obtaining a hashed word element of a large number of bits as the position of the word element in the word is closer to the forefront in the word.

3. The non-transitory computer-readable recording medium according to claim 2, wherein the obtaining further includes obtaining, when the position of the word element in the word is the forefront in the word, a hashed word element that has the number of bits associated with the forefront position in the word and that is fit to a character string distribution in a dictionary.

4. An encoding device comprising:
a processor; and
a memory, wherein the processor executes:
splitting a word to be encoded into a plurality of word elements;
obtaining a plurality of hashed word elements by hashing each of the plurality of word elements, number of bits of each of the plurality of hashed word elements corresponding to a position of each of the plurality of word elements in the word, respectively; and
outputting an encoding result that the plurality of the hashed word elements are combined.

5. An encoding method comprising:
splitting, performed by a computer, a word to be encoded into a plurality of word elements using a processor;
obtaining, performed by the computer, a plurality of hashed word elements by hashing each of the plurality of word elements, number of bits of each of the plurality of hashed word elements corresponding to a position of each of the plurality of word elements in the word, respectively using the processor; and
outputting, performed by the computer, an encoding result that the plurality of the hashed word elements are combined using the processor.

6. A computer-readable recording medium having stored therein a search program that causes a computer to execute a process comprising:
receiving a hashed word obtained from a word to be searched, the hashed word including each of the hashed word element having number of bits corresponding to a position of each of the plurality of word elements in the word; and
searching, on the basis of a dictionary that includes a hashed word and a word code for each word, for the word code that is associated with the hashed word.

7. A search device comprising:
a processor; and
a memory, wherein the processor executes:
receiving a hashed word obtained from a word to be searched, the hashed word including each of the hashed word element having number of bits corresponding to a position of each of the plurality of word elements in the word; and
searching, on the basis of a dictionary that includes a hashed word and a word code for each word, for the word code that is associated with the hashed word.

8. A search method comprising:
receiving a hashed word obtained from a word to be searched, the hashed word including each of the hashed word element having number of bits corresponding to a position of each of the plurality of word elements in the word; and
searching, on the basis of a dictionary that includes a hashed word and a word code for each word, for the word code that is associated with the hashed word.
